(19) United States
(12) Patent Application Publication
(10) Pub. No.: US 2005/0162164 A1
(43) Pub. Date: Jul. 28, 2005

(54) Probehead for nmr spectometer

(75) Inventors: Ago Samoson, Trummi (EE); Tiit Tuherm, Vilde tee (EE); Jaan Past, Tallinn (EE); Andres Reinhold, Tallinn (EE); Tiit Anupold, Tallinn (EE)

Correspondence Address: BRUCE E. LILLING;LILLING & LILLING P.C., P.O. BOX 560, GOLDEN BRIDGE, NY, 10526, US

(73) Assignee: KEEMILISE JA BIOOGILISE FUUSIKA INSTITUUT, Tallinn (EE)

(21) Appl. No.: 10/515,982

(22) PCT Filed: May 14, 2003
(86) PCT No.: PCT/EE03/00002

(51) Int. Cl. G01V 3/00

(52) U.S. Cl. 324/318; 324/322

(57) ABSTRACT

The invention relates to the probehead of nuclear magnetic resonance spectrometer comprising a frame, a radio frequency coil attached thereto and a rotor located inside the coil containing the examined sample, supported by bearings and provided with turbines at both ends, a source of compressed gas, an executive unit and a control unit. The innovative step involves using different turbines that make the rotor rotate in the same or in opposite directions and providing the executive unit with at least two compressed gas channels for rotor velocity control for each turbine, whereas the coil is connected to the inner surface of the frame with at least two, preferably four sheets of thin non-conductive and non-magnetic material. The rotation velocity of the probehead rotor can be controlled and the rotation direction reversed thereby obtaining additional information on the examined sample during the measuring process.

The invention relates to radiospectroscopy and deals in particular with probehead for nuclear magnetic resonance (NMR) measurement.

NMR is a method of radiospectroscopy for study of structural and dynamic properties of the matter. In order to narrow detected spectral lines and improve resolution, a fast mechanical rotation of the sample under certain angle with respect of the magnetic field direction is used. A known patent of E. Lippmaa et.al. U.S. Pat. No. 4,254,373, Int Cl³ G01R 33/08, 1981, describes a probehead, containing a rotor with the studied sample. A radio-frequency NMR coil is wound around the rotor, leaning on bearings and equipped with turbines, executive unit and control unit. A shortcoming of the known probehead is unvariable rotor speed, limiting the content of obtained information about the sample in certain cases.

The goal of the invention is to obtain information about the sample under conditions of fast rotor velocity change and inversion of the rotation direction.

The task is solved in such a manner, that in the NMR probehead, containing a sample in the rotor, surrounded by radio-frequency NMR coil, and supported by bearings and provided with the turbines at both ends, source of the compressed gas, execution unit and control unit, different turbines make the rotor rotate in the same or in opposite directions and executive unit comprises at least two compressed gas channel for rotor velocity control for each turbine. Sufficiently fast alteration of the rotor velocity and direction of rotation are possible by means of several turbines.

In the preferred embodiment there are two turbines at each end of the rotor and the executive unit has been provided with four velocity control compressed gas channels. Thus at each end of the rotor there's a turbine that makes the rotor rotate in one direction and another turbine that makes it rotate in the opposite direction. The increased number of turbines allows to increase the start acceleration of rotation by applying higher momentum to the rotor.

It is also preferred that the diameter of the cylindrical turbines is less than the diameter of the rotor when achieving maximum velocity in a provided direction of rotation is the relevant parameter. E.g. when the diameter of the cylindrical turbine is decreased two times, then at the same linear velocity the angular velocity doubles.

In order to achieve higher velocity and to speed up reversing the rotor's direction of rotation the dimensions of the turbines have been brought down to the minimum. But the relatively small volume of the rotor and thus the examined example in comparison with the area of the examined sample causes a distortion of the measured signal due to the inhomogeneity of the magnetic field during passage from one environment to another when the magnetic susceptibility of the environments is different. Therefore it is preferable either to unify the susceptibility or to minimize the mass of substance with different receptiveness around the rotor.

In order to decrease signal distortion the coil is preferably connected to the inner surface of the frame with at least two, preferably four sufficiently strong thin non-conductive and non-magnetic sheets that are preferably positioned radially. The most suitable material is ceramics. In order to combine the coil and the ceramic sheet the coil end of the ceramic sheet is provided with grooves that house coil sections.

The length and thickness ratio of the ceramic sheet is preferably 200:1 to 50:1. A higher ratio may cause the sheet to break, a lower ratio may cause the homogeneity of the magnetic field to be compromised.

Signal distortion by magnetic field inhomogenity is reduced by minimizing bulk volume of the coil and supporting construction. The coil is supported by very thin sheets or stripes of strong, non-conductive and non-magnetic material (typically technical ceramic). The rotor velocity of the probehead can be modified and direction of the rotation changed, all this enables to obtain additional information about the investigated sample. The information is detected in a form of electromagnetic waves, picked up by a special coil. The coil is located as close as possible around the rotor, and may need mechanical support for exact and stable positioning. The coil and support are carefully selected to avoid disturbance of the magnetic field homogeneity. Novel feature of present invention is also special support construction, designed to minimize bulk susceptibility changes around the sample. The support comprises two or more thin sheets of sufficiently strong material, fixing coil by either tangential or radial mechanical contact. Sufficiently high acceleration rates of the rotor can only be achieved for rotors of no more than few mm in diameter. Relatively small volume of the sample makes overall signal sensitive for construction features of details around the sample. Therefore, coil support presents a logical part of the whole probehead.

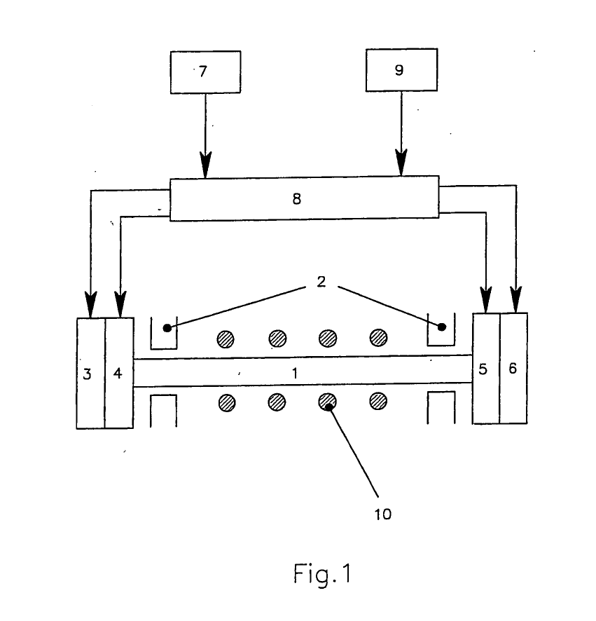

FIG. 1 presents a principal layout of four turbine probehead.

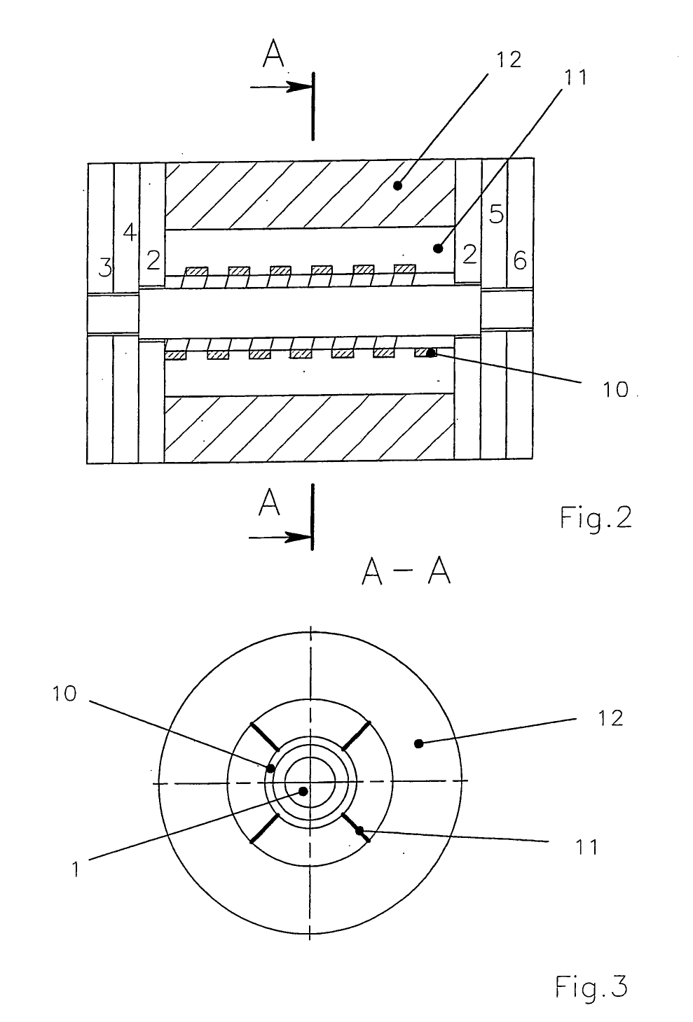

FIG. 2 presents construction for signal pickup coil support, based on radially arranged ceramic sheets.

FIG. 3 presents perpendicular view A-A from FIG. 2.

NMR probehead contains investigated sample, located in the rotor 1. The rotor 1 leans on bearings 2 and is equipped with turbines. The turbines 3 and 6 generate motion, which may be reversed compared to turbines 4 and 5. In principle, only two turbines are required for realising physical idea of the experiment. Larger number of turbines may be required to achieve sufficiently high acceleration rate of the rotor, by delivering more momentum to the rotor. The source of high-pressure gas 7 is connected with turbines via execution unit 8, which is operated by a control unit 9. Coil 10 is supported by very thin ceramic sheets 11, connected to the frame 12 e.g. by glued joint. Sufficiently high acceleration rates of the rotor can only be achieved for rotors of no more than few mm in diameter. Diameter of rotor in realized embodiment is 1.8 mm and diameter of working surface of turbines is 1.6 mm.

Operation principle of the NMR probehead is following. The rotor 1 is filled with a measured sample. A suitable combination of the turbines is selected to activate motion. Change of the rotor speed or its reversal is accomplished by execution unit 8. The execution unit 8 comprises either valves or switches, located either in the probehead or externally, and switched typically by electromagnets. The purpose being regulation of the pressure and amount of the compressed gas, flowing from the reservoir 7 to the turbines 3-6, as determined by signal from the control unit 9. For a rapid acceleration of the rotor, execution unit will increase gas pressure at forward turbines. Deceleration, stop or reversal of the rotor motion pressure is increased at counter-directed turbines, reducing simultaneously gas flow to forward turbines.

Total number of turbines can be two (one for each direction, or both same direction, one of which to provide acceleration), but in this case the efficiency of the rotor acceleration is correspondingly reduced.

Described probehead is applied for modification of dipolar interaction between atoms in studied sample. This process is able to carry spectral frequency, characterizing atom A, to atom B and further to atom C, proving spatial proximity of atoms A and C. Novel feature is using auxiliary, messenger atom B for information transport. The probehead enables also significantly more extended distance of the information transport.

Very important practical application of this probehead is a possibility to determine sequence of amino acids in peptides and proteins. Atoms A and B are alfa-carbons of the neighboring amino acids, auxiliary messenger atom is carbonyl carbon in between.

1. A probehead for measuring nuclear magnetic resonance that is comprised of a frame, a radio frequency coil attached thereto and a rotor located inside the coil containing the examined sample, supported by bearings and provided with turbines at both ends, a source of compressed gas, an executive unit and a control unit, characterized in that different turbines make the rotor rotate in the same or in opposite directions and the executive unit is provided at least two separate compressed gas channels for rotor velocity control for each turbine.

2. A probehead as claimed in claim 1 characterized in that at both ends of the rotor there are two turbines respectively to provide rotation in opposite directions and the executive unit has been provided with four compressed gas channels for rotor velocity control.

3. A probehead as claimed in claim 1 characterized in that the turbines are cylindrical and the diameter of their work area is less than the diameter of the rotor.

4. A probehead as claimed in claim 1 characterized in that the coil is connected to the inner surface of the frame with at least two, preferably four sheets of thin non-conductive and non-magnetic material.

5. A probehead as claimed in claim 4 characterized in that the sheets are made of ceramic material.

6. A probehead as claimed in claim 4 characterized in that the coil ends of the sheets comprise grooves for housing coil sections.

7. A probehead as claimed in claim 4 characterized in that the ratio of the length and thickness of the sheets is 200:1 to 50:1.
